(19) United States
(12) Patent Application Publication
(10) Pub. No.: US 2026/0319252 A1
(43) Pub. Date: Oct. 15, 2026

(54) OPTICAL MEMBER AND WEARABLE DEVICE INCLUDING SAME

(71) Applicant: LG INNOTEK CO., LTD., Seoul (KR)

(72) Inventors: Chul KIM, Seoul (KR); Eun Seong SEO, Seoul (KR); Joong Yeol KO, Seoul (KR); Ji Sung KIM, Seoul (KR)

(21) Appl. No.: 19/104,327

(22) PCT Filed: Aug. 8, 2023
(86) PCT No.: PCT/KR2023/011706

§ 371 Date: Feb. 17, 2025

(30) Foreign Application Priority Data
Aug. 17, 2022 (KR) 10-2022-0102879

(51) Int. Cl. G02B 27/01; G03B 21/28

(52) U.S. Cl. CPC G02B 27/0172; G02B 27/0176; G03B 21/28; G02B 2027/0178

(57) ABSTRACT

An optical member according to an embodiment comprises: a housing; a lens module disposed inside the housing; a first reflective member that reflects light emitted from the lens module; a second reflective member that reflects light reflected from the first reflective member; and an emitting member through which light reflected from the second reflective member is emitted. The light reflected by the second reflective member passes through the first reflective member and travels to the emitting member.

### TECHNICAL FIELD

Embodiments relate to an optical member and a wearable device including the same.

### BACKGROUND ART

Recent technological advancements have led to the development of various types of wearable devices that can be worn on the body. Among them, augmented reality (AR) devices are wearable devices in the form of glasses worn on the head of the user. An AR device provides visual information through a display. Thus, users can receive AR services.

AR is that three-dimensional images are inserted into the real environment and real world information is mixed with virtual images.

Real world information includes unnecessary information for users. Alternatively, real world information may lack necessary information for users. However, AR systems merge the real world and the virtual world. Thus, the interaction between the real world and the virtual world takes place in real time.

Unlike a virtual reality (VR) device that blocks the field of vision, the AR device does not block the field of vision while in use. In addition, the AR device displays a wide screen-level display in front of the eyes while worn like regular glasses. In addition, the AR device may provide extended reality, in which reality and AR content are combined, using a 360° space centered on a user. In addition, the AR device may provide an optimized display to a user in a hands-free state.

The AR device includes an optical module. The optical module provides AR images to users.

The optical module includes a light source and various optical components that control the movement of light. Light emitted by the light source is collected, reflected, and scanned through various optical components. Thus, the light moves to glass disposed outside the optical module.

The image quality, weight, or driving voltage of the AR device may vary according to the arrangement or size of the optical components disposed inside the optical module. Therefore, there is a need for a new optical member with a new structure capable of implementing the optimal image quality, driving voltage, and weight thereof.

### DISCLOSURE

### Technical Problem

Embodiments provide an optical member capable of being driven at low power, and a wearable device.

Embodiments provide an optical member having improved image quality, and a wearable device.

### Technical Solution

An optical member according to an embodiment includes a housing, a lens module disposed in the housing, a first reflective member configured to reflect light emitted by the lens module, a second reflective member configured to reflect the light reflected by the first reflective member, and an emission member configured to emit the light reflected by the second reflective member, wherein the light reflected by the second reflective member passes through the first reflective member to move to the emission member.

### Advantageous Effects

An optical member according to embodiments includes a reflective member. Light incident on and reflected by a second reflective member moves through the reflective member.

The reflective member includes two reflective portions. An angle between incident light and reflected light of the second reflective member is reduced by the reflective member. Accordingly, it is possible to prevent an increase in the size of the second reflective member in order to receive light incident on the second reflective member. Alternatively, an increase in inclination of a micro-electrical mechanical system (MEMS) member can be prevented.

Since the size and inclination of the second reflective member are reduced, the optical member can be driven with low power. In addition, the optical member can be miniaturized.

In addition, the angle and distance of a first reflective member, a lens module and the second reflective member are controlled. Accordingly, the optical loss of the optical member can be reduced, and improved image quality can be achieved.

### DESCRIPTION OF DRAWINGS

FIG. 1 is a perspective view of an optical member according to an embodiment.

FIG. 2 is an exploded perspective view of an optical member according to an embodiment.

FIG. 3 is a perspective view of an optical module according to an embodiment.

FIG. 4 is a perspective view of a reflective member of an optical module according to an embodiment.

FIG. 5 is a cross-sectional view of a reflective member of an optical module according to an embodiment.

FIGS. 6 and 7 are cross-sectional views of an optical module according to an embodiment.

FIGS. 8 to 15 are views illustrating a comparison between an optical module according to an example and an optical module according to a comparative example.

FIG. 16 is a flowchart of a method of driving an optical member according to a first embodiment.

FIG. 17 is a view for describing positions of a mirror and a sensor unit of an optical member according to an embodiment.

FIG. 18 is a flowchart of a method of driving an optical member according to a second embodiment.

FIG. 19 is a view illustrating a wearable device to which an optical member according to an embodiment is applied.

### MODES OF THE INVENTION

Hereinafter, exemplary embodiments of the present disclosure will be described with reference to the accompanying drawings.

However, the technical spirit of the present invention is not limited to some embodiments which will be described and may be realized using various other embodiments, and at least one component of the embodiments may be selectively coupled, substituted, and used to realize the technical spirit within the range of the technical spirit of the present invention. In addition, unless clearly and specifically defined otherwise by context, all terms (including technical and scientific terms) used herein may be interpreted as having customary meanings to those skilled in the art, and meanings of generally used terms, such as those defined in commonly used dictionaries, will be interpreted by considering contextual meanings of the related technology. In addition, the terms used in the embodiments of the present invention are for the purpose of describing the embodiments and are not intended to limit the present invention. In the present specification, unless clearly indicated otherwise by the context, singular forms include the plural forms thereof, and in a case in which “at least one (or one or more) among A, B, and C” is described, this may include at least one combination among all possible combinations which may be combined with A, B, and C. In addition, in descriptions of components of the present invention, terms such as “first,” “second,” “A,” “B,” “(a),” and “(b)” may be used. The terms are only to distinguish one element from another element, and an essence, order, and the like of the element are not limited by the terms. In addition, it should be understood that, when an element is referred to as being “connected or coupled” to another element, such a description may include both of a case in which the element is directly connected or coupled to another element and a case in which the element is connected or coupled to another element with still another element disposed therebetween.

In addition, in a case in which any one element is described as being formed or disposed “on or below” another element, such a description includes both cases in which the two elements are formed or disposed in direct contact with each other and in which one or more other elements are interposed between the two elements. In addition, when one element is described as being disposed “on or under” another element, such a description may include a case in which the one element is disposed at an upper side or a lower side with respect to another element.

Meanwhile, each member described below is defined by a vertical vector, an optical axis, or an extension. A first vertical vector V1 of a reflective member 400 or an extension of the first vertical vector V1 is defined. A second vertical vector V2 of an emission member 500 or an extension of the second vertical vector V2 is defined. An optical axis OA of a lens module or an extension of the optical axis OA is defined. An extension E1 of the emission member 500 and an extension E2 of the second reflective member are defined. Here, the extension E1 of the emission member 500 is perpendicular to the second vertical vector V2. The extension E2 of the second reflective member is perpendicular to the first vertical vector V1.

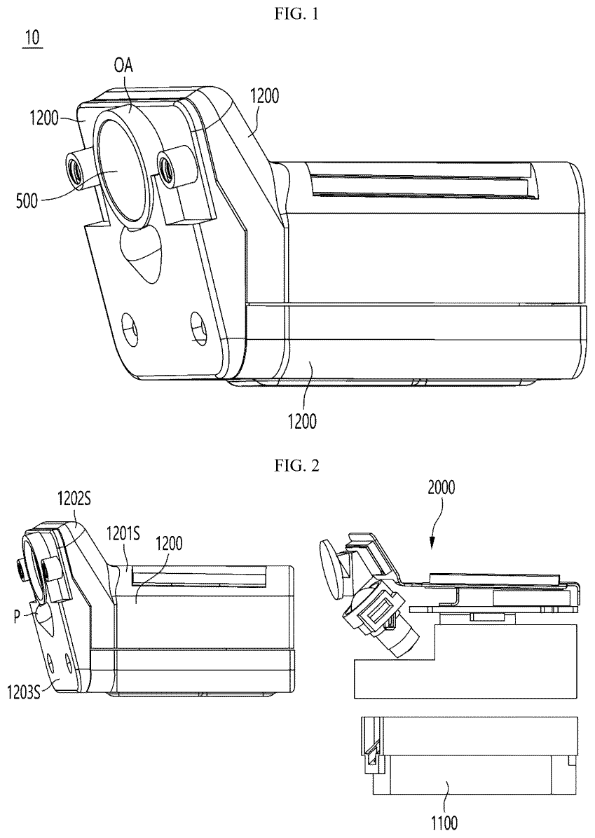

Hereinafter, an optical member according to an embodiment will be described with reference to FIGS. 1 to 5.

The optical member may be an optical member of a three-dimensional (3D) display. The optical member may be applied to a display device. The optical member may be applied to a wearable display device. For example, the optical member may be applied to an augmented reality (AR) device. The optical member may be a projector.

Referring to FIGS. 1 and 2, an optical member 10 includes a first housing 1100, a second housing 1200, and an optical module 2000. Each of the first housing 1100 and the second housing 1200 accommodates the optical module 2000.

The first housing 1100 accommodates a side portion of the optical module 2000. The first housing 1100 may surround a side surface of the optical module 2000.

The second housing 1200 accommodates the optical module 2000. The second housing 1200 accommodates the optical module 2000 of which the side portion is accommodated in the first housing 1100. The side portion of the optical module 2000 is accommodated in the first housing 1100. In addition, the second housing 1200 may surround a front surface of the optical module. That is, the first housing 1100 and the optical module 2000 are accommodated in the second housing 1200.

The second housing 1200 includes an opening OA. The optical module 2000 is partially exposed by the opening 1200. That is, the emission member 700 of the optical module 2000 is coupled to the opening OA. Accordingly, light travelling in the optical module 2000 moves to the outside of the optical member 10 through the emission member 700.

The second housing 1200 includes three surfaces. Specifically, the second housing 1200 includes a first surface 1201S, a second surface 1202S, and a third surface 1203S. The third surface 1203S may include a protrusion P1. The second surface 1202S is disposed to be inclined with respect to the first surface 1201S.

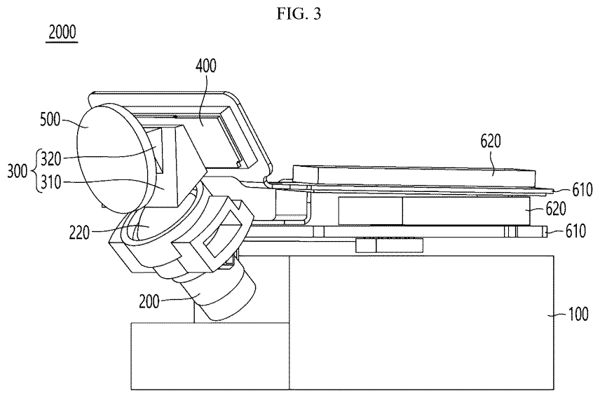

FIG. 3 is a perspective view of the optical module 2000.

Referring to FIG. 3, the optical module 2000 includes a light source member 100, a lens module 200, a first reflective member 300, a second reflective member 400, the emission member 500, and a plurality of circuit members 610 and 620.

The circuit members include a circuit board 610 and a driving member 620 disposed on the circuit board 610. The circuit board 610 includes at least one printed circuit board of a flexible printed circuit board (FPCB) and a printed circuit board (PCB). The circuit board 610 supports at least one member of the light source member 100, the lens module 200, the first reflective member 300, and the second reflective member 400. Alternatively, the circuit board 610 is connected to at least one member of the light source member 100, the lens module 200, the first reflective member 300, and the second reflective member 400.

The driving member 620 may include various driving components such as a driving driver.

The light source member 100, the lens module 200, the first reflective member 300, the second reflective member 400, the emission member 500, and the plurality of circuit members 610 and 620 are accommodated in the first housing 1100 and the second housing 1200.

Light generated by the light source member 100 may sequentially move to the lens module 200, the first reflective member 300, the second reflective member 400, and the emission member 500. That is, the light may be reflected, transmitted, or refracted by the lens module 200, the first reflective member 300, the second reflective member 400, and the emission member 500.

The light source member 100 generates light. The light moves toward the emission member 500. The light may include laser light.

The light source member 100 emits light having at least one color. For example, the light source member 100 may emit light having one color. Alternatively, the light source member 100 may emit a plurality of light beams having different colors.

For example, the light source member 100 may emit a plurality of light beams having different colors. For example, the light source member 100 may emit red light, green light, and blue light. That is, the light source member 100 may be a laser package that emits laser beams having a plurality of colors.

The light moves to the lens module 200. The light may move directly to the lens module 200. Alternatively, the light may move indirectly to the lens module 200. For example, at least one reflective member may be disposed between the light source member 100 and the lens module 200. The reflective member may collect the light or change a path of the light. The light may be incident on the lens module 200 through the reflective member. For example, the reflective member may include a mirror or a prism.

When the reflective member is provided, an angle formed by a straight line passing through a center of the light source member 100 and an optical axis of the lens module may be in a range of 90° to 180° or 120° to 150°.

Light emitted by the light source member 100 is incident on the lens module 200. That is, the lens module 200 is disposed in front of an emission surface of the light source member.

The light moves from the lens module 200 to the first reflective member 300.

The lens module 200 includes at least one lens, and for example, the lens module 200 may include a plurality of lenses. For example, the lens module 200 may include three or more lenses spaced apart from each other and a barrel for accommodating the lenses. Specifically, the lens module 200 may include three to six lenses spaced apart from each other. At least one lens of the lenses may have a different material, size, or shape from other lenses. For example, the lens module 200 may include a first lens 210 and a second lens 220. Light emitted by the light source member 100 is incident on the first lens 210. The light moves to the first reflective member 300 through the second lens.

Meanwhile, a portion of the second lens 220 may be disposed between the second reflective member 400 and the emission member 500 in a direction of a second vertical vector V2 of the emission member 500.

In addition, a center of the second lens 220 may be positioned between an extension E2 of the second reflective member 400 and an extension E1 of the emission member 500 in the direction of the second vertical vector V2 of the emission member 500.

That is, the first lens 210 is disposed closest to an incident portion of the lens module 200. In addition, the second lens 220 is positioned closest to an emission portion of the lens module 200.

Therefore, a distance between the second lens 210 and the emission member 500 is smaller than a distance between the first lens 210 and the emission member 500. In other words, a travelling distance of light between the second lens 220 and the emission member 500 is smaller than a travelling distance of light between the first lens 210 and the emission member 500.

Specifically, based on the vertical vector direction of the emission member 500, a distance between an optical axis of the second lens 220 and the extension E1 of the emission member 500 is smaller than a distance between an optical axis of the first lens 210 and the extension E1 of the emission member 500.

The lens module 200 controls an emission angle of light travelling toward the first reflective member 300. Specifically, the lens module 200 controls an emission angle of light travelling to the outside of the lens module 200. For example, the lens module 200 may be a relay lens that controls the emission angle of the light.

Since the emission angle of the light is controlled by the lens module 200, an incidence area of light incident on the emission member 500 is reduced. Accordingly, it is possible to prevent an increase in the size of the emission member due to an increase in the emission angle of the light.

Light emitted by the lens module 200 is incident on the first reflective member 300. The first reflective member 300 is disposed in front of an emission surface of the lens module 200.

The first reflective member 300 may include a plurality of reflective portions. Specifically, the first reflective member 300 includes a reflective portion 310 and a light guide portion 320. The reflective portion 310 and the light guide portion 320 may face each other. In addition, the reflective portion 310 and the light guide portion 320 may be spaced apart from each other.

The first reflective member 300 may reflect or transmit the light according to an incident angle of incident light. That is, the first reflective member 300 may be a total reflection prism.

Light reflected by the first reflective member 300 moves to the second reflective member 400. Light reflected by the second reflective member 400 passes through the first reflective member 300 and moves to the emission member 500.

A difference between an incident angle of light travelling from the first reflective member 300 to the second reflective member 400 and a reflection angle of light reflected by the second reflective member 400 to the first reflective member 300 is controlled by the first reflective member 300. Accordingly, since a size of the second reflective member 400 is reduced, the performance of the optical module 10 is improved.

The first reflective member 300 is described in detail below.

Light reflected by the first reflective member 300 is incident on the second reflective member 400. The second reflective member 400 faces an emission surface of the first reflective member 300. In addition, the second reflective member 400 faces a reflective surface of the first reflective member 300.

Accordingly, the first reflective member 300 is disposed between the second reflective member 400 and the emission member 500.

The second reflective member 400 includes a support portion 410 and a mirror 420 disposed on the support portion 410.

The support portion 410 includes a magnet that generates an electromagnetic force. The mirror 420 is driven in a horizontal and a vertical direction by the electromagnetic force.

The mirror 420 may rotate in a first direction and a second direction. That is, the mirror 420 may rotate in two directions. In addition, the mirror 420 reflects light while rotating in two directions. Accordingly, the second reflective member 400 may perform scanning in a vertical direction and a horizontal direction.

Specifically, the second reflective member 400 receives light from the light source member 100, the lens module 200, and the first reflective member 300 and projects the received light in the horizontal and vertical directions. For example, the second reflective member 400 projects synthesized light in a direction parallel to a first line (horizontal scanning). Next, the second reflective member 400 vertically moves to a second line (vertical scanning). Next, light is projected in a direction parallel to a second line (horizontal scanning). That is, the second reflective member 400 moves in an X-axis direction and a Y-axis direction. In addition, the scanning is repeated in the horizontal direction and the vertical direction. Thus, the second reflective member 400 may project an image onto the emission member 500. In an embodiment, the second reflective member 400 may be a micro-electrical mechanical system (MEMS) scanner. However, embodiments are not limited thereto. The second reflective member 400 may be a MEMS scanner, a mirror, or a prism.

Light scanned in the second reflective member 400 is incident on the emission member 500. The emission member 500 may include glass. The emission member 500 may be inserted into the opening OA.

The emission member 500 faces the first reflective member 400. For example, the emission member 500 may face two surfaces of the first reflective member 400 having an inclination.

Although not shown in the drawings, a wave guide may be disposed outside the optical module 10. Light passing through the emission member 500 may be reflected by the wave guide to which a hologram is attached. Accordingly, through the wave guide, light may be incident on the eyes of a user who wears a display device including the optical module.

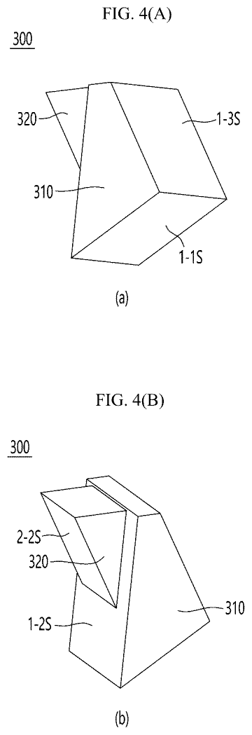

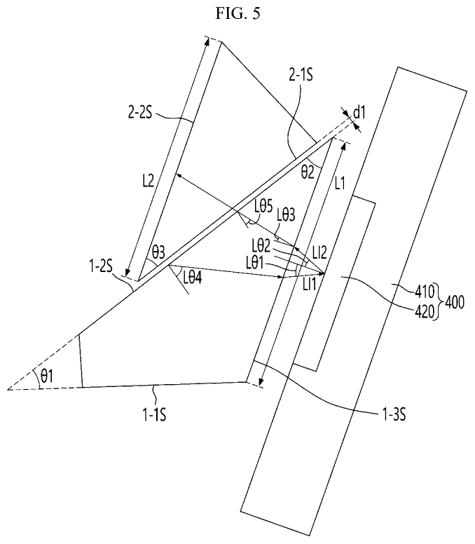

Hereinafter, the reflective members will be described in detail with reference to FIGS. 4 and 5.

Referring to FIGS. 4 and 5, the first reflective member 300 includes the reflective portion 310 and the light guide portion 320. At least one of the reflective portion 310 and the light guide portion 320 includes a total reflection surface. The reflective portion 310 reflects light incident from the lens module 200 to the second reflective member 400. In addition, the light guide portion 320 guides light reflected by the second reflective member 400 to the emission member 500. Thus, light reflected through the second reflective member 400 may pass through the first reflective member 300 to move to the emission member 500.

At least one of the reflective portion 310 and the light guide portion 320 may include glass or plastic. The reflective portion 310 and the light guide portion 320 may include the same material or different materials.

An angle between first light LI1 emitted to the second reflective member 400 and second light LI2 reflected by the second reflective member 400 is reduced by the reflective portion 310. Accordingly, a size of the mirror 420 of the second reflective member 400 is reduced by the first reflective member 510. Thus, a force for driving the mirror 420 is reduced. In addition, a size of the support portion 410 supporting the mirror 420 is also reduced. Accordingly, the size of the second reflective member 400 is reduced. Accordingly, the optical module can be miniaturized.

In addition, light emitted to the emission member 500 moves in a parallel direction by the second reflective member 400. Accordingly, an amount of light incident on the emission member 500 increases. Therefore, optical efficiency is improved.

Each of the reflective portion 310 and the light guide portion 320 includes a plurality of surfaces. Specifically, the reflective portion 310 and the light guide portion 320 include the plurality of surfaces through which light is incident, reflected, or emitted.

The reflective portion 310 includes a 1-1 surface 1-1S, a 1-2 surface 1-2S, and a 1-3 surface 1-3S.

The 1-1 surface 1-1S is a surface on which the light is incident. Specifically, the first surface 1-1S faces the second lens 220 which is the last lens among the lenses of the lens module 200. Light passing through the lens module 200 is incident on the 1-1 surface 1-1S. Light incident on the 1-1 surface 1-1S moves to the 1-2 surface 1-2S.

The 1-2 surface 1-2S is a surface through which the light is reflected or transmitted. Specifically, the 1-2 surface 1-2S may reflect or transmit light according to an incident angle of light incident on the 1-2 surface 1-2S. That is, the 1-2 surface 1-2S may reflect light when an incident angle of light incident on the 1-2 surface 1-2S is greater than a critical angle and may transmit light when an incident angle is less than the critical angle. For example, the reflective portion 310 may be a total reflection prism.

Light incident from the 1-1 surface 1-1S to the 1-2 surface 1-2S is incident at an incident angle that is greater than the critical angle. Accordingly, light incident on the 1-2 surface 1-2S is reflected toward the 1-3 surface 1-3S.

The 1-3 surface 1-3S is a surface through which the light is emitted and incident. Light reflected from the 1-2 surface 1-2S is incident on the 1-3 surface 1-3S. Light passing through the 1-3 surface 1-3S moves to the second reflective member 400. In addition, the light reflected after scanned through the second reflective member 400 moves to the 1-3 surface 1-3S.

Light incident on the 1-3 surface 1-3S again moves to the 1-2 surface 1-2S. Light incident on the 1-2 surface 1-2S is incident at an incidence angle that is less than the critical angle. Thus, light passes through the 1-2 surface 1-2S to move to the light guide portion 320.

The light guide portion 320 includes a 2-1 surface 2-1S and a 2-2 surface 2-2S.

The 2-1 surface 2-1S is a surface through which light is incident or emitted. Specifically, light that passes through the 1-2 surface 1-2S to move to the second light guide portion 320 is incident on the 2-1 surface 2-1S. In addition, the light moves to the 2-2 surface 2-2S.

The 2-2 surface 2-2S is a surface through which light is incident and emitted. Specifically, light emitted from the 2-1 surface 2-1S is incident on the 2-2 surface 2-2S. In addition, light moves from the 2-2 surface 2-2S to the emission member 500.

The reflective portion 310 and the light guide portion 320 face each other. Specifically, the reflective portion 310 and the light guide portion 320 include surfaces facing each other. More specifically, one surface of the reflective portion 310 faces one surface of the light guide portion 320. More specifically, the 1-2 surface 1-2S of the reflective portion 310 faces the 2-1 surface 2-1S of the light guide portion 320.

In addition, the reflective portion 310 and the light guide portion 320 are spaced apart from each other. Specifically, one surface of the reflective portion 310 is spaced apart from one surface of the light guide portion 320. Specifically, the 1-2 surface 1-2S is spaced apart from the 2-1 surface 2-1S.

A distance d1 between one surface of the reflective portion 310 and one surface of the light guide portion 320 may be 0.005 mm or more. Specifically, the distance d1 may be 0.01 mm or more. More specifically, the distance d1 may be 0.02 mm or more. More specifically, the distance d1 may be in a range of 0.005 mm to 0.03 mm. More specifically, the distance d1 may be in a range of 0.01 mm to 0.03 mm.

When the distance d1 is less than 0.005 mm, the reflective portion 310 and the light guide portion 320 may collide with each other due to an error during a process or an external impact.

In addition, when the distance d1 exceeds 0.03 mm, a size of the optical module may increase.

That is, the 1-2 surface 1-2S and the 2-1 surface 2-1S are spaced apart from and face each other.

In addition, the reflective portion 310 and the light guide portion 320 are disposed parallel to each other. Specifically, one surface of the reflective portion 310 is parallel to one surface of the light guide portion 320. Specifically, the 1-2 surface 1-2S of the reflective portion 310 is parallel to the 2-1 surface 2-1S of the light guide portion 320.

In addition, one surface of the reflective portion 310 and one surface oof the light guide portion 320 are disposed parallel to the second reflective member 400. Specifically, the 1-2 surface 1-2S and the 2-1 surface 2-1S are parallel to the mirror 420. More specifically, the 1-2 surface 1-2S and the 2-1 surface 2-1S may be parallel to one surface of the mirror 420 before the mirror 420 rotates.

In addition, the 1-3 surface 1-3S is parallel to the 2-2 surface 2-2S.

The reflective portion 310 and the light guide portion 320 have different sizes. Specifically, the reflective portion 310 is larger than the light guide portion 320. More specifically, the reflective portion 310 is longer than the light guide portion 320.

In addition, a length L1 of the 1-3 surface 1-3S is in a set range. Specifically, the length L1 may be 0.5 mm or more. More specifically, the length L1 may be 1 mm or more. More specifically, the length L1 may be 2 mm or more. More specifically, the length L1 may be 3 mm or more. More specifically, the length L1 may be in a range of 0.5 mm to 4 mm.

When the length L1 is less than 0.5 mm, all light reflected from the 1-2 surface 1-2S may not be incident on the 1-3 surface 1-3S. Alternatively, all light reflected by the second reflective member 400 may not be incident on the 1-3 surface 1-3S.

In addition, when the length L1 exceeds 4 mm, the size of the optical module 2000 may increase.

In addition, a length L2 of the 2-2 surface 2-2S is in a set range. Specifically, the length L2 may be 0.5 mm or more. More specifically, the length L2 may be 1 mm or more. More specifically, the length L2 may be 2 mm or more. More specifically, the length L2 may be 3 mm or more. More specifically, the length L2 may be in a range of 0.5 mm to 4 mm.

When the length L2 is less than 0.5 mm, all light incident by being emitted from the 1-2 surface 1-2S and the 2-1 surface 2-1S may not be incident on the 2-2 surface 2-2S.

In addition, when the length L2 exceeds 4 mm, the size of the optical module 2000 may increase.

In addition, the length L1 and the length L2 may be the same or different.

For example, the length L1 may be greater than the length L2. Accordingly, when light moves to the second reflective member 400, the light may move through the 1-3 surface 1-3S without light loss. Alternatively, when light is reflected by the second reflective member 400, the light may move through the 1-3 surface 1-3S without light loss.

Alternatively, the length L2 may be greater than the length L1. Accordingly, when light moves to the emission member 500 through the 2-2 surface 2-2S, the light may easily move even when the size of the emission member 600 changes.

The first reflective member 300 may satisfy the following expressions. Specifically, the first reflective member 300 may satisfy at least one of the following expressions.

$$1.3 \leq nt\_ 1 \leq 2.1 , \qquad [ Expression 1 ]$$

$$1.35 \leq nt\_ 1 \leq 2.05 ,$$

$$1.4 \leq nt\_ 1 \leq 2. , or$$

$$1.5 \leq nt\_ 1 \leq 1.9$$

nt_1 denotes a refractive index of the reflective portion 310 with respect to light in a d-line (587.6 nm) wavelength band.

$$1.3 \leq nt\_ 2 \leq 2 \text{.1} , \qquad [ Expression 2 ]$$

$$1.35 \leq nt\_ 2 \leq 2.05 ,$$

$$1.4 \leq nt\_ 2 \leq 2. , or$$

$$1.5 \leq nt\_ 2 \leq 1.9$$

nt_2 denotes a refractive index of the light guide portion 320 with respect to light in a d-line (587.6 nm) wavelength band.

$$0 \leq \vert nt\_ 1 - nt\_ 2 \vert \leq 0.01 \qquad [ Expression 3 ]$$

The first reflective member 300 may satisfy Expressions 1 to 3. Accordingly, when light moves to the emission member through the reflective portion 310 and the light guide portion 320, light loss due to a difference in refractive index between the first reflective portion and the second reflective portion can be prevented.

$$θ 1 = θ 2 = θ 3 \qquad [ Expression 4 ]$$

θ1 denotes an angle formed by the 1-1 surface 1-1S and the 1-2 surface 1-2S. θ1 denotes angle formed by a long side of the 1-1 surface and a long side of the 1-2 surface 1-2S. θ2 denotes an angle formed by the 1-2 surface 1-2S and the 1-3 surface 1-3S. θ2 denotes an angle formed by a long side of the 1-2 surface 1-2S and a long side of the 1-3 surface 1-3S. θ3 denotes an angle formed by the 2-1 surface 2-1S and the 2-2 surface 2-2S. θ3 is an angle formed by a long side of the 2-1 surface 2-1S and a long side of the 2-2 surface 2-2S.

The first reflective member 300 may satisfy Expression 4. Accordingly, it is possible to prevent a chromatic aberration from occurring inside the first reflective member 300. Accordingly, a display can have improved picture quality.

$$\vert L θ 1 \vert = \vert L θ 2 \vert , and \qquad [ Expression 5 ]$$

$$L θ1 < L θ2 - 6 < L θ 2 < L θ 2 + 6$$

Lθ1 denotes an angle between light emitted from the 1-3 surface 1-1S and incident on the second reflective member 400 and the vertical vector of the second reflective member 400. Lθ2 denotes an angle between light reflected by the second reflective member 400 and incident on the 1-3 surface 1-1S and the vertical vector of the second reflective member 400.

$$0 ° < \vert L θ 1 \vert + \vert L θ 2 \vert < 12 ° \qquad [ Expression 6 ]$$

The first reflective member 300 may satisfy Expressions 5 and 6. Accordingly, light emitted from the 1-3 surface 1-1S and incident on the second reflective member 400 may be separated from light reflected by the second reflective member 400 and incident on the 1-3 surface 1-1S.

In addition, the size of the second reflective member 400 may decrease. That is, the size of the mirror 420 may decrease. Accordingly, since a weight of the second reflective member 400 is reduced, the driving efficiency of the second reflective member 400 is improved. In addition, the optical module is miniaturized.

$$when 1.45 < nt\_ 1 < 1.5 , \qquad [ Expression 7 ]$$

$$4 < L θ3 .$$

Lθ3 denotes an angle between light emitted from the 1-3 surface 1-1S and a vertical vector of the 1-3 surface 1-1S when light reflected by the second reflective member 400 is incident on the 1-3 surface 1-3S.

$$when 1.65 < nt\_ 1 < 1.75 , \qquad [ Expression 8 ]$$

$$3.5 < L θ3 .$$

$$when 1.85 < nt\_ 1 < 1.95 , \qquad [ Expression 9 ]$$

$$3.2 < L θ3 .$$

The first reflective member 300 may satisfy Expressions 7 to 9. Accordingly, light reflected by the second reflective member 400, refracted from the 1-3 surface 1-3S, and incident on the 1-2 surface 1-2 may move toward the light guide portion 320 without being totally reflected from the 1-2 surface 1-2.

$$25 ° \leq CR\_ 1 - 2 S \leq 43 ° , or \qquad [ Expression 10 ]$$

$$28 ° \leq CR\_ 1 - 2 S \leq 41 ° .$$

CR_1-2S is a critical angle of the 1-2 surface 1-2S.

$$L θ 4 = θ 2 + L θ 3 \qquad [ Expression 11 ]$$

Lθ4 denotes an angle between light emitted from the 1-2 surface 1-2S and a vertical vector of the 1-2 surface 1-2S.

$$L θ 5 = θ2 - L θ3 \qquad [ Expression 12 ]$$

Lθ5 denotes an angle between light reflected by the second reflective member 400 and incident on the 1-2 surface 1-2S and the vertical vector of the 1-2 surface 1-2S.

$$32 \leq θ 2 \leq 52 , \qquad [ Expression 13 ]$$

$$36 \leq θ2 \leq 48 ,$$

$$40 \leq θ 2 \leq 44 , or$$

$$41.5 \leq θ 2 \leq 42.5$$

The first reflective member 300 may satisfy Expressions 11 to 13. Accordingly, a size of the first reflective member 300 decreases. In addition, all light may move inside the first reflective member 300. In addition, light incident on the second reflective member 400 may be reflected form the 1-2 surface 1-2S. In addition, light reflected by the second reflective member 400 may pass through the 1-2 surface 1-2S.

$$20 ° < θ 400 - TIR < 50 ° \qquad [ Expression 14 ]$$

θ 400-TIR is an angle between an optical axis of the lens of the lens module and the vertical vector of the 1-2 surface 1-2S.

The first reflective member 300 may satisfy Expression 14. Therefore, light incident from the lens module is totally reflected toward the second reflective member 400 without passing through the 1-2 surface 1-2S.

The first reflective member 300 may satisfy at least one of Expressions 1 to 14. Specifically, the first reflective member 300 may satisfy all Expressions 1 to 14.

Accordingly, the size of the second reflective member decreases. Therefore, the optical member 10 can be miniaturized. In addition, clear image quality can be formed by correcting an aberration of light emitted by the optical module 2000. In addition, a driving force of the second reflective member is reduced. Therefore, the optical module can be driven with low power. Accordingly, an operating time and a lifetime of the display device are improved.

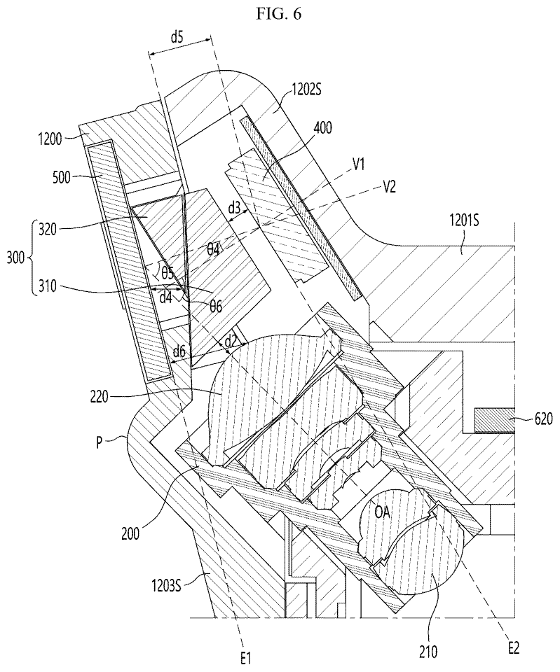

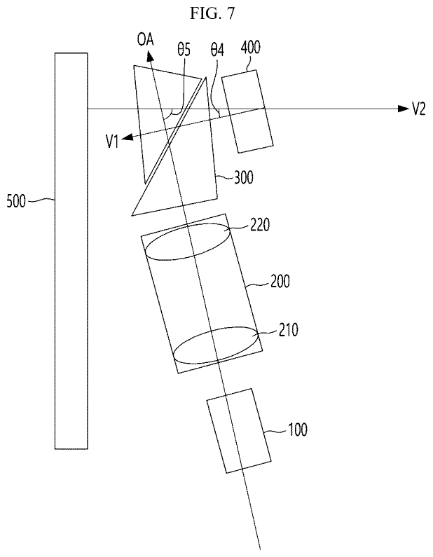

FIGS. 6 and 7 are cross-sectional views of a part of the optical module according to an embodiment.

Referring to FIGS. 6 and 7, a vertical vector, an optical axis, or an extension of each member is defined. Specifically, the second vertical vector V2 of the emission member 500 or an extension of the second vertical vector V2 is defined. In addition, the first vertical vector V1 of the second reflective member 400 or an extension of the first vertical vector V1 is defined. In addition, an optical axis OA of the lens module or an extension of the optical axis OA is defined. In addition, the extension E1 of the emission member 500 and the extension E2 of the second reflective member are defined. The extension E1 of the emission member 50 is perpendicular to the second vertical vector V2. The extension E2 of the second reflective member is perpendicular to the first vertical vector V1.

Referring to FIGS. 6 and 7, the first reflective member 300 is spaced apart from at least one of the lens module 200, the second reflective member 400, and the emission member 500.

The first reflective member 300 is spaced apart from the lens module 400.

A distance d2 between the first reflective member 300 and the lens module 200 is different from the distance d1 between one surface of the reflective portion 310 and one surface of the light guide portion 320. Specifically, the distance d2 is greater than the distance d1.

Specifically, the distance d2 may be 0.1 mm or more. More specifically, the distance d2 may be 0.3 mm or more. More specifically, the distance d2 may be in a range of 0.1 mm to 0.5 mm. More specifically, the distance d2 may be in a range of 0.2 mm to 0.3 mm.

The distance d2 is the minimum distance from the reflective portion 310 to the center of the second lens 220 which is the last lens of the lens module 200.

When the distance d2 is less than 0.1 mm, the first reflective member 300 and the lens module 200 may come into contact with each other due to an error during a process. In addition, when an external impact is applied to the optical member 10, the first reflective member 300 and the lens module 200 may collide with each other due to the impact.

When the distance d2 exceeds 0.5 mm, a distance between the first reflective member 300 and the lens module 200 unnecessarily increases. Therefore, the size of the optical module may increase.

The first reflective member 300 and the second reflective member 400 are spaced apart from each other.

A distance d3 between the first reflective member 300 and the second reflective member 400 may be different from the distance d1. Specifically, the distance d3 is greater than the distance d1.

Specifically, the distance d3 may be 0.1 mm or more. More specifically, the distance d3 may be 0.4 mm or more. More specifically, the distance d3 may be in a range of 0.1 mm to 0.6 mm. More specifically, the distance d3 may be in a range of 0.3 mm to 0.5 mm.

The distance d3 is the minimum distance from the reflective portion 310 to a center of the second reflective member 400.

When the distance d3 is less than 0.1 mm, the first reflective member 300 and the second reflective member 400 may come into contact with each other due to an error during a process. In addition, when an external impact is applied to the optical member 10, the first reflective member 300 and the second reflective member 400 may collide with each other due to the impact.

When the distance d3 exceeds 0.6 mm, a distance between the first reflective member 300 and the second reflective member 400 unnecessarily increases. Therefore, the size of the optical module may increase.

The first reflective member 300 is spaced apart from the emission member 500.

A distance d4 between the first reflective member 300 and the emission member 500 may be 0.03 mm or more. Specifically, the distance d4 may be 0.05 mm or more. More specifically, the distance d4 may be in a range of 0.03 mm to 0.08 mm. More specifically, the distance d4 may be in a range of 0.06 mm to 0.07 mm.

The distance d4 is the minimum distance between the first reflective member 300 and the emission member 500.

A process of reducing the distance d4 to less than 0.05 mm may be difficult. In addition, when the distance d4 is less than 0.05 mm, the first reflective member 300 and the emission member 500 may come into contact with each other due to an error during a process. In addition, when an external impact is applied to the optical member 10, the first reflective member 300 and the emission member 500 may collide with each other due to the impact.

When the distance d4 exceeds 0.08 mm, a distance between the first reflective member 300 and the emission member 500 unnecessarily increases. Therefore, the size of the optical module may increase.

The second reflective member 400 is disposed to be inclined. Specifically, the second reflective member 400 is inclined toward the emission member 500. An inclination of the second reflective member 400 is an angle between the second reflective member 400 and the emission member 500. Specifically, the first vertical vector V1 of the second reflective member 400 is defined. In addition, the second vertical vector V2 of the emission member 500 is defined. The inclination of the second reflective member 400 is an angle between the first vertical vector V1 and the second vertical vector V2.

The angle between the first vertical vector V1 and the second vertical vector V2 has a set size.

An angle θ4 between the first vertical vector V1 and the second vertical vector V2 may be 10° or more. Specifically, the angle θ4 may be 20° or more. More specifically, the angle θ4 may be in a range of 10° to 30°. More specifically, the angle θ4 may be in a range of 15° to 20°.

In addition, the second reflective member 400 is inclined at the above angle range toward the emission member 500. In addition, incident light and reflected light of the second reflective member 400 satisfy Expression 6.

The second reflective member 400 is positioned to be inclined at an angle in a set range. Therefore, light incident from the first reflective member 300 to the second reflective member 400 is reflected by the second reflective member 400. In addition, the reflected light is incident on the first reflective member 300. That is, the first reflective member 300 is disposed between the lens module 200 and the second reflective member 400. Even when the second reflective member 400 is inclined at a small angle, due to the first reflective member, light reflected by the second reflective member 400 may be stably incident on the emission member 500 while passing through the first reflective member 300.

The second reflective member 400 is inclined at a small angle. Accordingly, the second reflective member 400 can be prevented from coming into contact with the first reflective member 300 and the second housing 1200. In addition, the second surface 1202S of the second housing is inclined at a certain angle with respect to the first surface 1201S of the second housing. An angle between the first surface 1201S and the second surface 1202S is greater than 110° and less than 130°.

The second reflective member 400 is spaced apart from the second housing 1200.

A distance d5 between the second reflective member 400 and the second housing 1200 may be 0.7 mm or more. Specifically, the distance d5 may be 0.9 mm or more. More specifically, the distance d5 may be in a range of 0.7 mm to 1.2 mm. More specifically, the distance d5 may be in a range of 1.0 mm to 1.1 mm.

The distance d5 is a distance from the center of the second reflective member 400 to an inner surface of the second housing 1200.

When the distance d5 is less than 0.7 mm, the second reflective member 400 and the second housing 1200 may come into contact with each other due to an error during a process. In addition, when an external impact is applied to the optical member 10, the second reflective member 400 and the second housing 1200 may collide with each other due to the impact.

When the distance d5 exceeds 1.2 mm, a distance between the second reflective member 400 and the second housing 1200 unnecessarily increases. Therefore, the size of the optical module may increase.

The lens module 200 is positioned to be inclined. Specifically, the lens module 200 is inclined toward the emission member 500. An inclination of the lens module 200 is an angle between the lens module 200 and the emission member 500. Specifically, the second vertical vector V2 of the emission member 500 is defined. In addition, the optical axis OA of the lens module 200 is defined. The inclination of the lens module 200 is an angle between the extension of the second vertical vector V2 and the extension of the optical axis OA.

An angle between the second vertical vector V2 and the optical axis OA has a set size.

An angle θ5 between the second vertical vector V2 and the optical axis OA may be 50° or more. Specifically, the angle θ5 may be 55° or more. More specifically, the angle θ5 may be in a range of 50° to 70°. More specifically, the angle θ5 may be in a range of 58° to 63°.

When the angle θ5 is 50° or less, the first lens 210 that causes light emitted by the light source member 100 to be incident on the lens module 200 is far from the third surface 1203S of the second housing. Accordingly, the size of the optical module 2000 increases.

When the angle θ5 is 70° or more, the first lens 210 is positioned very close to the third surface 1203S of the second housing. Therefore, a space for an arrangement of the light source member 100 becomes narrow. Therefore, it is difficult to assemble the light source member 100.

At least one reflective member (not shown) may be further disposed between the first lens 210 and the light source member 100. The reflective member may reflect light emitted by the light source member 100 to the first lens 210. When the angle θ5 is 70° or more, the first lens 210 is positioned very close to the third surface 1203S of the second housing. Therefore, a space for an arrangement of the reflective member becomes narrow. Therefore, it is difficult to assemble the reflective member (not shown).

The optical axis OA of the lens module 200 and the second reflective member 400 have an angle in a set range.

An angle θ6 between the optical axis OA of the lens module 200 and the first vertical vector V1 of the second reflective member 400 may be 90° or less. Specifically, the angle θ6 may be 80° or less. More specifically, the angle θ6 may be in a range of 70° to 105°. More specifically, the angle θ6 may be in a range of 75° to 98°.

When the angle θ6 is less than 70° or greater than 105°, light emitted by the lens module 200 is reflected by the first reflective member 300. Accordingly, light incident on the second reflective member 400 and light reflected therefrom may overlap each other.

When the 06 is less than 70°, the first lens 210 is far from the third surface 1203S of the second housing. Accordingly, the size of the optical module 2000 increases. When the 06 exceeds 105°, the first lens 210 is disposed very close to the third surface 1203S of the second housing. Accordingly, a space for an arrangement of the light source member 100 or the reflective member (not shown) becomes narrow. Therefore, it is difficult to assemble the light source member 100 and the reflective member (not shown).

In order to arrange the lens module 200 satisfying the above angle range, the third surface 1203S of the second housing includes the protrusion P1. The protrusion P1 protrudes outward from the emission member 500. The protrusion P1 protrudes outward further than the emission member 500.

The lens module 200 and the emission member 500 are spaced a set distance from each other. Specifically, a distance d6 between the lens module 200 and the emission member 500 is the minimum distance between the lens module 200 and the emission member 500 in a direction of the first vertical vector.

The distance d6 may be 0.8 mm or more. Specifically, the distance d6 may be 0.9 mm or more. More specifically, the distance d6 may be in a range of 0.8 mm to 1.2 mm. More specifically, the distance d6 may be 0.9 in a range of mm to 1.1 mm.

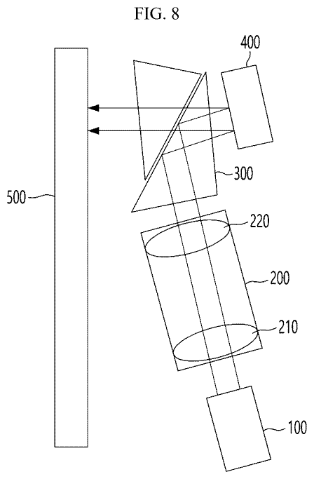

Hereinafter, an optical module including the reflective member and an optical module not including the reflective member will be described with reference to FIGS. 8 to 15.

Referring to FIGS. 8 and 13, the optical module includes the reflective member. The second lens 220 is positioned closer to the emission member 500 than the first lens 210.

The first reflective member 300 is disposed between the lens module 200 and the second reflective member 400. Accordingly, the assembly of internal components becomes easier while the performance of the optical module is maintained. In addition, the optical module is miniaturized.

When a distance between the first lens 210 of the lens module 200 and the emission member 500 increases, the performance of the optical module is maintained. In addition, the optical module is easy to assemble and is miniaturized. That is, the first lens 210 should be positioned to not be close to the emission member 500.

The first lens 210 is disposed close to the light source member 100. When the first lens 210 and the emission member 500 are adjacent to each other, a space in which the reflective member is disposed becomes narrower. Accordingly, the assembly of the optical module becomes difficult.

That is, when the first lens 210 is disposed to be close to the emission member 500, the light source member 100 or the reflective member is disposed between the first lens 210 and the emission member 500. Therefore, since the number of constraints increases, assembly is not easy. In particular, assembly should be performed such that light may be incident on the lens module 200 without contact with the emission member 500. Therefore, since the number of assembly conditions increases, assembly becomes difficult.

On the other hand, when a distance between the first lens 210 and the emission member 500 increases, the light source member 100 or an additional reflective member is not disposed between the emission member 500 and the lens module 200. Therefore, assembly becomes easier.

That is, when the distance between the emission member 500 and the first lens 210 is greater than a distance between the emission member 500 and the second lens 220, the light source member 100 or an additional reflective member is not disposed between the emission member 500 and the lens module 200. Therefore, assembly becomes easier.

That is, when the first lens 210 is positioned to not be close to the emission member 500, the light source member 100 or an additional reflective member is not positioned between the emission member 500 and the lens module 200. Therefore, assembly becomes easier.

When a reflective member is disposed between the lens module 200 and the second reflective member 400 as shown in FIG. 8 and FIG. 13, the first lens 210 may be disposed to not be close to the emission member 500.

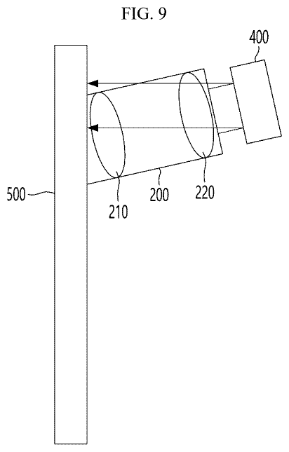

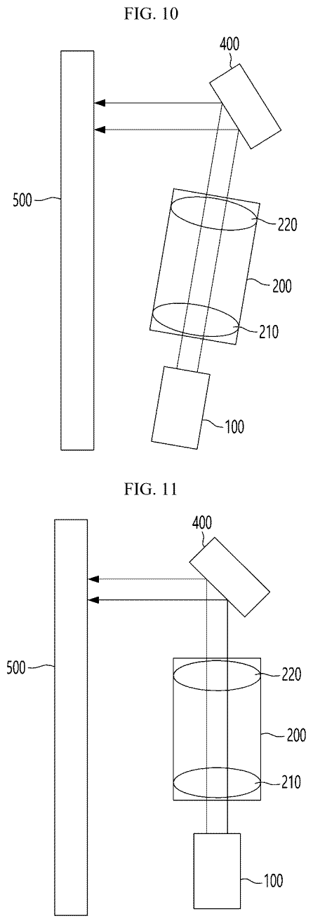

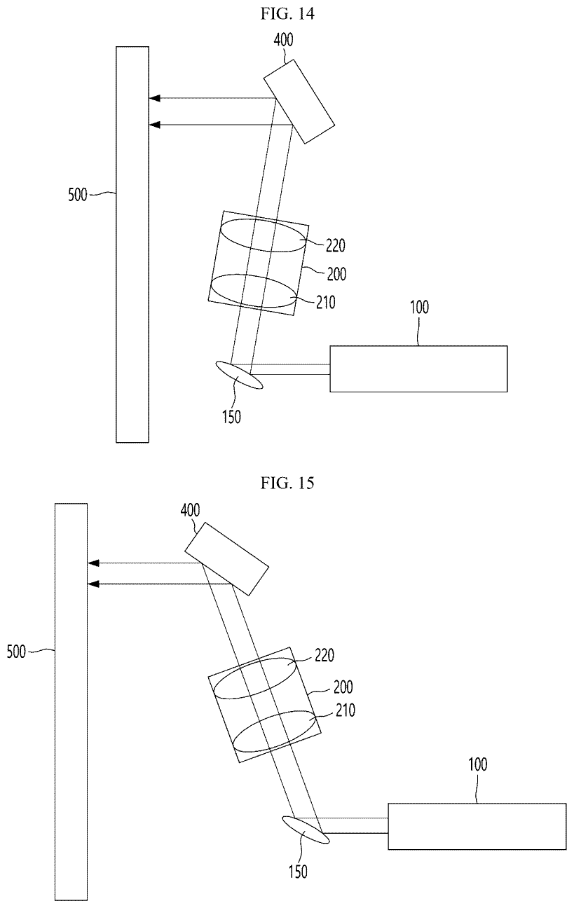

FIGS. 9, 10, and 14 are views illustrating a case in which the lens module is disposed without the reflective member. Referring to FIG. 9, the lens module is designed such that the light source member cannot be disposed. Referring to FIGS. 10 and 14, the light source member or the reflective member is disposed between the emission member 500 and the lens module 200. Therefore, assembly is not easy. Therefore, the optical module is miniaturized but is not easy to assemble.

FIGS. 11, 12, and 15 are views illustrating a case in which the reflective member is not disposed, and the lens module 200 is positioned to not be close to the emission member. Referring to FIGS. 11, 12, and 15, even when the reflective member is not disposed, a distance between the emission member 500 and the first lens 210 may be greater than a distance between the emission member 500 and the second lens 220. Accordingly, the light source member 100 or an additional reflective member may be positioned to not be adjacent to the emission member 500. Therefore, assembly may be easy, but the optical module is not miniaturized. That is, when the reflective member is not disposed, and the lens module 200 is disposed to not be close to the emission member 500, a distance between the lens module 200 and the emission member 500 increases. Therefore, the optical module is not miniaturized.

That is, since the first reflective member 300 is disposed between the second reflective members, assembly becomes easier while the performance of the optical module is maintained. In addition, an optical member is miniaturized.

Meanwhile, the second reflective member 400 is inclined at an angle set between the first vertical vector V1 and the second vertical vector V2. In addition, the lens module 200 is inclined at an angle set between the second vertical vector V2 and the optical axis OA.

That is, in the optical module according to the embodiment, the first reflective member 300 is disposed between the lens module 200 and the second reflective member 400. Therefore, both inclination angles of the second reflective member 400 and the lens module 200 can be satisfied.

Referring to FIG. 10 in which the first reflective member 300 is not included, the inclination angle of the second reflective member 400 is satisfied. However, the inclination angle of the lens module 200 is not satisfied.

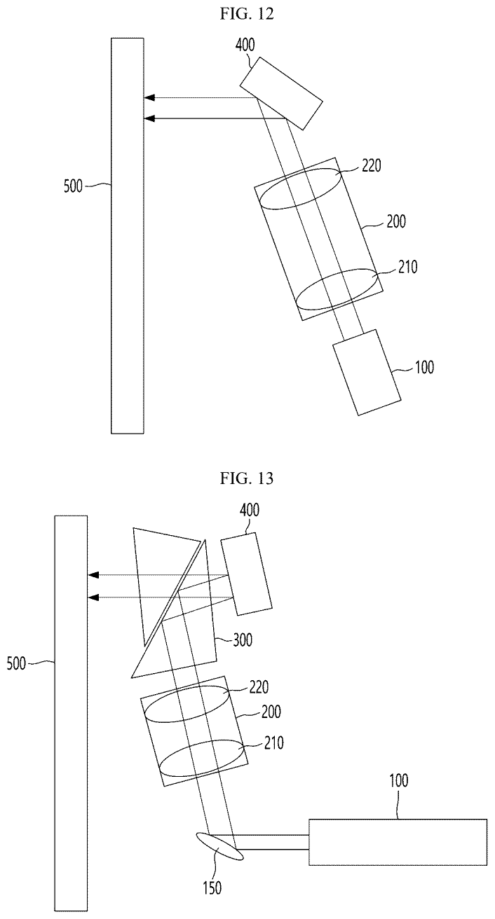

Referring to FIG. 12 in which the first reflective member 300 is not included, the inclination angle of the lens module 200 is satisfied. However, the inclination angle of the second reflective member 400 is not satisfied.

When both the inclination angles of the second reflective member 400 and the lens module 200 are satisfied, light incident on the second reflective member 400 and light reflected therefrom may be prevented from overlapping each other. Therefore, the optical module can maintain improved resolution. In addition, the assembly of the optical member becomes easier. In addition, the optical member is miniaturized.

The optical performance of the optical member is for displaying a clear screen. That is, the optical performance minimizes light loss, aberration, and distortion characteristics when light generated from the light source member is emitted to the emission member 500. Thus, light can be transmitted to the emission member without noise.

When an angle of the second reflective member 400 is out of the above range, an angle of the lens module 200 is also out of the above range. Accordingly, the emission member and the lens module are disposed close to each other. Therefore, a space for an arrangement of the light source member or an additional reflective member becomes narrow. Therefore, the assembly of the optical module becomes very difficult. In addition, the emission member and the lens module are very far away from each other. Therefore, the optical member is not miniaturized.

The angle and distance between the lens module 200 and the emission member 500 are conditions for the performance, assembly ease, and miniaturization of the optical member.

Referring to FIG. 10, the shortest distance between the emission member 500 and the second lens 220 is satisfied. However, the angle between the lens module 200 and the emission member 500 is not satisfied. Accordingly, the optical module can be miniaturized. However, assembly becomes difficult.

Referring to FIG. 12, the angle between the lens module 200 and the emission member 500 is satisfied. However, the shortest distance between the emission member 500 and the second lens 220 is not satisfied. Accordingly, assembly of the optical module becomes easier. However, miniaturization becomes difficult.

That is, only when the first reflective member 300 is disposed between the lens module 200 and the second reflective member 400, the lens module and the emission member satisfy conditions of the inclination angle and the distance. Therefore, the optical module can be miniaturized and easily assembled.

When the shortest distance between the emission member 500 and the second lens 220 is out of the above range, a distance between the emission member and the lens module decreases. Therefore, the assembly and miniaturization of optical modules become difficult.

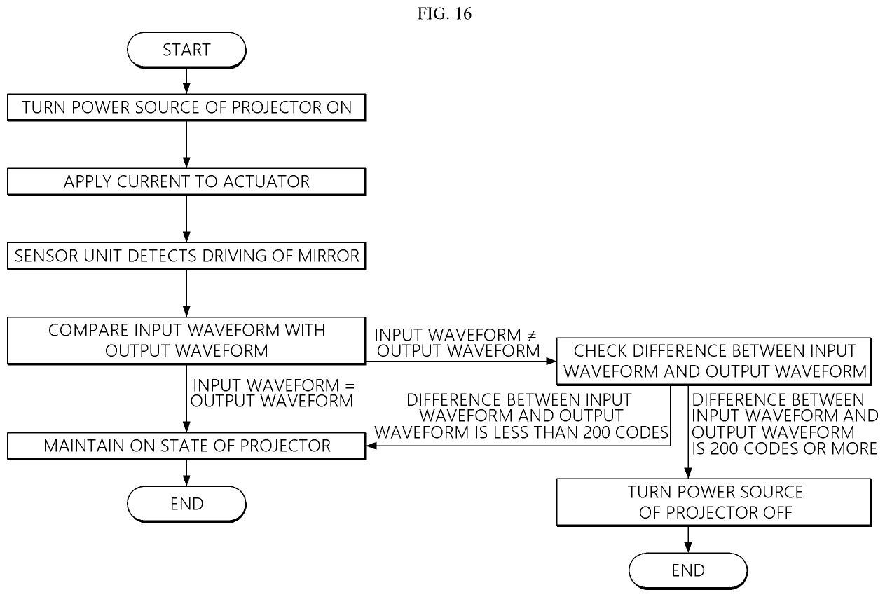

Hereinafter, a method of driving an optical member will be described with reference to FIGS. 16 to 18.

The optical member includes a MEMS scanner that rotates in a horizontal and/or a vertical direction. When the MEMS scanner does not rotate in a desired direction or by a desired extent, the characteristics of light travelling to the emission member change. For example, light travelling through the emission member may not be diffused to a sufficient extent. Alternatively, the intensity of light may be concentrated in a specific area. Accordingly, the user's eyesight may be reduced by the light.

Hereinafter, a method of driving an optical member, which may solve the above problems, will be described.

FIG. 16 is a flowchart of a method of driving an optical member according to a first embodiment. For example, FIG. 16 is a flowchart of a method of driving a projector.

The method of driving an optical member includes operation ST10 of turning a projector on, operation ST20 of applying a current to an actuator, operation ST30 of sensing, by a sensor unit, an output waveform of a mirror, and operation ST40 of comparing an input waveform with the output waveform.

First, the projector 1000 is turned on. When the projector 1000 is turned on, light is emitted by the light source member 100. Specifically, a laser is emitted by the light source member 100. More specifically, light including red light, green light, and blue light is emitted by the light source member 100.

Light emitted by the light source member 100 passes through the lens module 200, is reflected by the reflective members 300 and 400, and moves to the emission member 500.

Next, a current in a set range is applied to the projector 1000. Specifically, a current is applied to rotate the reflective member 300. Therefore, a current is applied to the actuator. A current in a set range is applied to the actuator. Specifically, a reference waveform for rotating the mirror 320 is set before a current is applied to the actuator. For example, the reference waveform may be a waveform at which the mirror 320 is torsionally driven. That is, the reference waveform becomes the input waveform, and then the input waveform is compared with the output waveform detected by the sensor unit.

A current with a magnitude sufficient for generating the reference waveform is applied to the actuator.

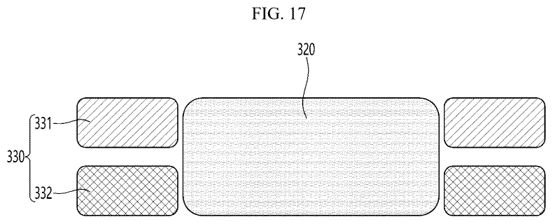

Next, the sensor unit detects the driving of the mirror. Referring to FIG. 17, a sensor unit 330 is disposed adjacent to the mirror 320. The sensor unit 330 includes a first sensor unit 331 positioned at an upper side and a second sensor unit 332 positioned at a lower side. The first sensor unit 331 and the second sensor unit 332 detect the movement of the mirror 320 driven by the actuator. Specifically, the first sensor unit 331 and the second sensor unit 332 detect a change in position of the mirror 320. The first sensor unit 331 and the second sensor unit 332 may include a piezorestive (PZR) sensor.

Accordingly, the sensor unit 330 may generate an output waveform according to an applied current.

Next, the input waveform is compared with the output waveform. The input waveform is the reference waveform. That is, the input waveform is a waveform at which the mirror 320 is torsionally driven. In addition, the output waveform is a waveform at which the sensor unit 330 detects the mirror 320 moved by the actuator.

Through the comparison between the input waveform and the output waveform, it is determined whether the input waveform matches the output waveform.

When the input waveform matches the output waveform, the projector maintains an on state.

When the input waveform does not match the output waveform, a difference between the input waveform and the output waveform is checked. When the difference between the input waveform and the output waveform is less than 200 codes, the projector maintains an on state. When the difference between the input waveform and the output waveform is 200 codes or more, the projector is turned off.

When the difference between the input waveform and the output waveform is 200 codes or more, the intensity of light reflected by the reflective members 300 and 400 may be concentrated in a local area. Thus, the user's eyesight may be affected.

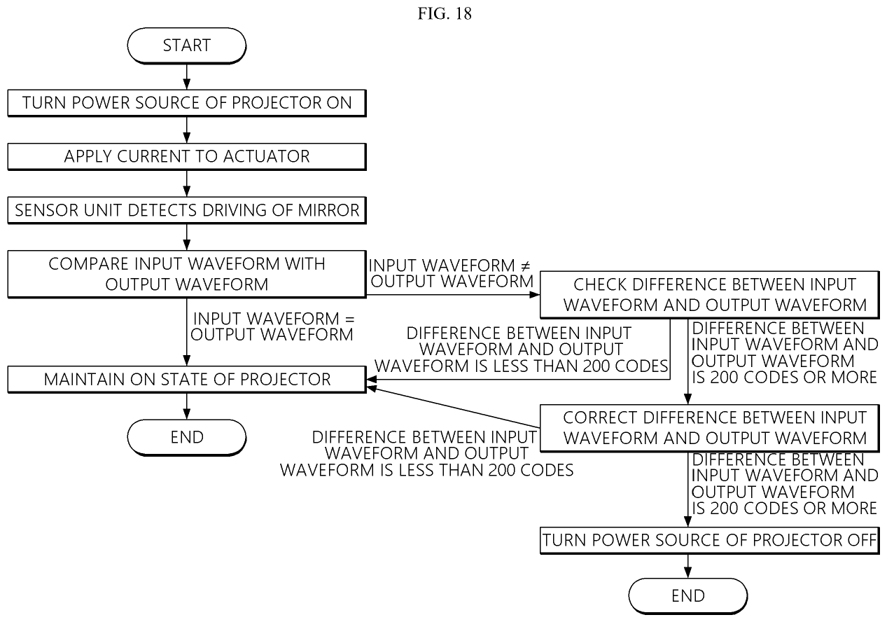

Next, a method of driving an optical member according to a second embodiment will be described with reference to FIG. 18.

The method of driving a projector according to the second embodiment includes operation ST10 of turning a projector on, operation ST20 of applying a current to an actuator, operation ST30 of sensing, by a sensor unit, an output waveform of a mirror, operation ST40 of comparing an input waveform with the output waveform, operation ST50 of checking a difference between the input waveform and the output waveform, and operation ST50 of correcting the difference between the input waveform and the output waveform.

First, a projector 1000 is turned on. When the projector 1000 is turned on, light is emitted by the light source member 100. Specifically, a laser is emitted by the light source member 100. More specifically, light including red light, green light, and blue light is emitted by the light source member 100.

Light emitted by the light source member 100 passes through the lens module 200, is reflected by the reflective members 300 and 400, and moves to the emission member 500.

Next, a current in a set range is applied to the projector 1000. Specifically, a current is applied to rotate the reflective member 300. Therefore, a current is applied to the actuator. A current in a set range is applied to the actuator. Specifically, a reference waveform for rotating the mirror 320 is set before a current is applied to the actuator. For example, the reference waveform may be a waveform at which the mirror 320 is torsionally driven. That is, the reference waveform becomes the input waveform, and then the input waveform is compared with the output waveform detected by the sensor unit.

A current with a magnitude sufficient for generating the reference waveform is applied to the actuator.

Next, the sensor unit detects the driving of the mirror. Specifically, the movement of the mirror 320 driven by the actuator is detected through the sensor unit 330. Specifically, a change in position of the mirror 320 is detected.

Accordingly, the sensor unit 330 generates an output waveform according to an applied current.

Next, the input waveform is compared with the output waveform. The input waveform may be the reference waveform. That is, the input waveform may be a waveform at which the mirror 320 is torsionally driven. In addition, the output waveform is a waveform at which the sensor unit 330 detects the mirror 320 moved by the actuator.

Through the comparison between the input waveform and the output waveform, it is determined whether the input waveform matches the output waveform.

When the input waveform matches the output waveform, the projector maintains an on state.

When the input waveform does not match the output waveform, a difference between the input waveform and the output waveform is checked. When the difference between the input waveform and the output waveform is less than 200 codes, the projector maintains an on state. When the difference between the input waveform and the output waveform is 200 codes or more, the difference between the input waveform and the output waveform is corrected.

In the correction of the difference between the input waveform and the output waveform, a driving force of the actuator is changed. For example, the movement of the mirror may be increased by increasing the driving force of the actuator. Alternatively, the movement of the mirror may be reduced by reducing the driving force of the actuator.

Alternatively, in the correction of the difference between the input waveform and the output waveform, a frequency of the mirror is changed. That is, the frequency of the mirror may be increased or decreased.

When the difference between the input waveform and the output waveform is corrected to be less than 200 codes, the projector maintains an on state. In addition, when the difference between the input waveform and the output waveform is maintained at 200 codes or more, the projector is turned off.

When the difference between the input waveform and the output waveform is 200 codes or more, the intensity of light reflected by the reflective member 300 may be concentrated in a local area. Thus, the user's eyesight may be affected.

In the method of driving an optical member, the user's eyesight can be protected.

Specifically, the projector detects the movement of the mirror through the actuator. When an error occurs in the movement of the mirror, the projector may be turned off. When the mirror is driven differently from a set movement, light reflected through the reflective member may be concentrated in a local area.

When light reflected by the reflective member is concentrated in one area, strong light may be transmitted to the user's eyes. Thus, the user's eyesight may be affected.

Therefore, when an error occurs in the movement of the mirror, the projector is turned off. Accordingly, the user's eyesight can be protected.

In addition, when an error occurs in the movement of the mirror, the movement of the mirror is corrected. Accordingly, a user may detect and correct the movement of the mirror while using the projector.

Therefore, user convenience is increased because the projector is not turned off immediately.

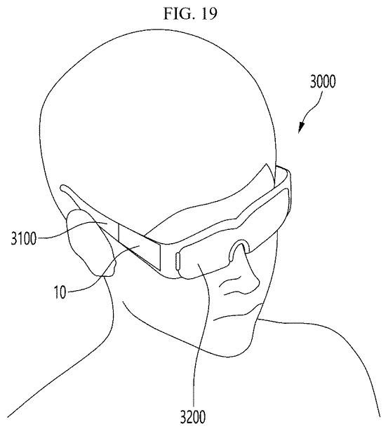

Hereinafter, a display device including an optical member 10 according to an embodiment will be described with reference to FIG. 19.

Referring to FIG. 19, the optical member 10 is applied to a wearable display device. Specifically, the wearable display device may be worn on the head or ear of a human body.

As an example, a display device 3000 may be an AR device.

The display device 3000 includes a wearable part 3100, an optical member 10, and a display part 3200.

The wearable part 3100 extends in one direction. The wearable part 3100 may be worn on the body of a user. For example, the wearable part 3100 is worn on the head or ear of a user. Accordingly, the display device 3000 is fixed to the body of the user.

The optical member 10 is connected to the wearable part 3100. The optical member 10 is adjacent to the display part 3200. The optical member 10 transmits light scanned as an image toward the display part 3200. In addition, light passing through the display part 3200 is transmitted to the eyes of a user.

Accordingly, the user perceives AR through the optical element.

The features, structures, effects, and the like described in the embodiments above are included in at least one embodiment of the present invention and are not necessarily limited to only one embodiment. Furthermore, the features, structures, effects, and the like exemplified in each embodiment can be combined or modified and implemented in other embodiments by a person having ordinary knowledge in the art to which the embodiments belong. Therefore, the contents related to these combinations and modifications should be interpreted as being included within the scope of the present invention.

In addition, while the present invention has been described with reference to embodiments, this is merely an example and is not intended to limit the present invention, and those skilled in the art to which the present invention pertains will be able to understand that various modifications and applications not exemplified above are possible without departing from the essential characteristics of the present embodiments. For example, each component specifically shown in the embodiments may be implemented by modification. In addition, differences related to the modifications and applications should be construed as being included in the scope of the present invention defined in the appended claims.

1-10. (canceled)

11. An optical member comprising:
a housing;
a light source member and a lens module disposed in the housing;
a first reflective member configured to reflect light emitted by the lens module;
a second reflective member configured to reflect the light reflected by the first reflective member; and
an emission member configured to emit the light reflected by the second reflective member,
wherein the lens module includes a first lens on which light emitted by the light source member is incident, and a second lens configured to deliver the light to the second reflective member, and
wherein a distance between an optical axis of the second lens and an extension of the emission member is smaller than a distance between an optical axis of the first lens and the extension of the emission member, and
the distances are in a direction of a vertical vector of the emission member.

12. The optical member of claim 11, wherein the light reflected by the second reflective member passes through the first reflective member to move to the emission member.

13. The optical member of claim 12, wherein the first reflective member includes a reflective portion and a light guide portion, and
the reflective portion reflects the light emitted by the lens module to the second reflective member.

14. The optical member of claim 13, wherein the light guide portion guides the light reflected by the second reflective member to the emission member.

15. The optical member of claim 11, wherein an angle between an extension of an optical axis of the lens module and a vertical vector of the second reflective member is in a range of 70° to 105°.

16. The optical member of claim 15, wherein the angle between the extension of the optical axis of the lens module and the vertical vector of the second reflective member is an angle between the lens module and the second reflective member.

17. The optical member of claim 11, wherein the lens module is disposed in front of the light source member, and
the emission member faces an emission surface of the first reflective member.

18. The optical member of claim 17, wherein the second reflective member faces a reflective surface of the first reflective member, and
the first reflective member is disposed between the second reflective member and the emission member.

19. The optical member of claim 18, comprising a reflective member disposed between the light source member and the lens module.

20. The optical member of claim 19, wherein an angle between a straight line passing through a center of the light source member and an optical axis of the lens module is greater than 90° and less than 180°.

21. The optical member of claim 11, wherein an extension of the second reflective member is a line extending in a direction perpendicular to a vertical vector of the second reflective member, and
the extension of the emission member is a line extending in a direction perpendicular to the vertical vector of the emission member.

22. The optical member of claim 21, wherein an optical axis of the lens module is inclined at an angle of 50° to 70° with respect to a direction of the vertical vector of the emission member.

23. The optical member of claim 22, wherein a minimum distance between the emission member and the second lens is in a range of 0.8 mm to 1.2 mm and is in the direction of the vertical vector of the emission member.

24. The optical member of claim 11, wherein a portion of the second lens is disposed between the second reflective member and the emission member in a direction of the vertical vector of the emission member.

25. The optical member of claim 24, wherein a center of the second lens is positioned between an extension of the second reflective member and an extension of the emission member in the direction of the vertical vector of the emission member.

26. The optical member of claim 13, wherein at least one of the reflective portion and the light guide portion includes a total reflection surface.

27. The optical member of claim 26, wherein the reflective portion includes a 1-1 surface on which the light is incident, a 1-2 surface on which the light is reflected or transmitted, and 1-3 surface on which the light is emitted and incident.

28. The optical member of claim 27, wherein the light guide portion includes 2-1 surface and 2-2 surface on which the light is incident or emitted, and
the 1-2 surface and the 2-1 surface are spaced apart.

29. The optical member of claim 28, wherein a distance between the 1-2 surface and the 2-1 surface is 0.005 mm to 0.03 mm.

30. The optical member of claim 29, wherein the 1-2 surface and the 2-1 surface are parallel.
